(19) United States
(12) Patent Application Publication
(10) Pub. No.: US 2026/0163177 A1
(43) Pub. Date: Jun. 11, 2026

(54) NOTCHING AND STACKING DEVICE FOR ELECTRODE ASSEMBLY AND SECONDARY BATTERY AND ELECTRODE ASSEMBLY AND SECONDARY BATTERY MANUFACTURED USING THE SAME

(71) Applicant: SAMSUNG SDI CO., LTD., Yongin-si (KR)

(72) Inventors: Hyun Woo KIM, Yongin-si (KR); Sun Yhik AHN, Yongin-si (KR)

(21) Appl. No.: 19/220,304

(22) Filed: May 28, 2025

(30) Foreign Application Priority Data
Dec. 6, 2024 (KR) 10-2024-0180072

(51) Int. Cl. H01M 50/406; H01M 10/04; H01M 50/46

(52) U.S. Cl. CPC H01M 50/406; H01M 10/0404; H01M 50/46

(57) ABSTRACT

A notching and stacking device for an electrode assembly including a die having holes, the die including a first die having a separator mounted thereon and having a first die hole and a second die located on an upper side of the first die, the second die having an electrode plate mounted thereon and having a second die hole corresponding to the first die hole; a punch disposed at the upper side of the die and penetrating the hole of the first die and the hole of the second die to notch the electrode plate and the separator; and a stitching part in close contact with inner circumferences of the holes of the die. The stitching part is configured to stitch and fix a notched separator and a stacked separator by using a fixing thread.

### CROSS-REFERENCE TO THE RELATED APPLICATION

The present application claims priority to and the benefit of Korean Patent Application No. 10-2024-0180072, filed on Dec. 6, 2024, in the Korean Intellectual Property Office, the entire disclosure of which is incorporated herein by reference.

### BACKGROUND

### 1. Field

Embodiments of the present disclosure relate to a notching and stacking device for an electrode assembly and a secondary battery and to an electrode assembly and a secondary battery manufactured using the notching and stacking device.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Such secondary batteries can be manufactured by alternately stacking or winding a negative electrode plate, a positive electrode plate, and a separator. A stacked secondary battery includes a separate device for notching each of the negative electrode plate, the positive electrode plate, and the separator, and a separate stacking device is provided for stacking each of the notched negative electrode plate, positive electrode plates, and separator. However, the notching device and a cell stack manufacturing device require a large area of space, and there is a possibility that product defects may occur due to distortion during a stacking process.

The above information disclosed in this Background section is for enhancement of understanding of the background of the present disclosure, and therefore, it may contain information that does not constitute related (or prior) art

### SUMMARY

The present disclosure provides a notching and stacking device for an electrode assembly and a secondary battery and to an electrode assembly and a secondary battery manufactured by using the same, in which a stack and a separator can be fixed by stitching at the same time as notching. Thus, product defects due to distortion that occurs during stacking of the electrode assembly can be prevented.

These and other aspects and features of the present disclosure will be described in or will be apparent from the following description of embodiments of the present disclosure.

According to an embodiment of the present disclosure for solving the technical problem, a notching and stacking device for an electrode assembly may include a die having holes, the die including a first die having a separator mounted thereon and having a first die hole, and a second die located on an upper side of the first die, the second die having an electrode plate mounted thereon and having a second die hole corresponding to the first die hole, a punch disposed at the upper side of the die and penetrating the hole of the first die and the hole of the second die to notch the electrode plate and the separator, and a stitching part in close contact with inner circumferences of the holes of the die, the stitching part configured to stitch and fix a notched separator and a stacked separator by using a fixing thread.

The punch may further include an auxiliary part, which protrudes from a side wall of the punch, the auxiliary part located on an upper side of the stitching part.

The auxiliary part may be spaced upward and apart from a lower surface of the punch by a first height.

The stitching part may include a gasket having a square ring shape on a plane and having a plurality of through holes extending through the gasket, the through holes penetrating an upper side of the gasket and a lower side of the gasket, and needles placed in the through holes of the gasket and capable of moving in a third direction, including an upward direction and a downward direction, by using the gasket as a guide, and a thread connected to a thread hook part of each of the needles.

A height of the gasket may be greater than or equal to a sum of a thickness of the electrode plate and a first height of which the auxiliary part may be spaced upward and apart from a lower surface of the punch.

A cutting part for cutting the separator may be on an outer circumference on a lower side of the gasket.

The gasket may have a plurality of through holes on at least both sides, the through holes on each side facing each other for receiving the needles.

The auxiliary part may be on an upper side of the gasket.

The notching and stacking device may further include a stack die aligned with and placed on a lower side of the holes of the die. A portion of the separator notched via the punch and a portion of the electrode plate notched via the punch may be sequentially stacked on the upper side of the stack die.

According to another embodiment of the present disclosure for solving the technical problem, an electrode assembly manufactured by the notching and stacking device for the electrode assembly may include a first electrode plate, a first separator, a second electrode plate, and a second separator, all of which may be in a plate shape and of which may be sequentially and alternately stacked. A first region between the second separator and the first separator may be coupled by a first fixing thread, and a first electrode plate may be in the first region between the second separator and the first separator. A second region between the first separator and the second separator may be coupled by a second fixing thread, and a second electrode plate may be in the second region between the first separator and the second separator.

The first region and the second region may not overlap on a plane.

Each of the first fixing thread and the second fixing thread may include a main thread stitched through and between the first separator and the second separator with one thread, and an upper looper and a lower looper respectively connected to upper and lower sides of the main thread.

Each of the first fixing thread and the second fixing thread may include a plurality of main threads stitched from top to bottom through and between the first separator and the second separator and may include a lower looper coupled to a lower side of the plurality of main threads.

The first electrode plate may include a first electrode tab protruding in a first direction from one end of the first electrode plate, and the second electrode plate may include a second electrode tab protruding in the first direction from one end of the second electrode plate and being spaced apart in a second direction from the first electrode tab.

Each of the first fixing thread and the second fixing thread fix together a side of the first separator and a side of the second separator along the first direction.

A plane size of the separator may be larger than a plane size of the first electrode plate or the second electrode plate, and the first electrode plate and the second electrode plate do not overlap on a plane in the first region and the second region.

According to another embodiment of the present disclosure for solving the technical problem, a secondary battery including the electrode assembly may include a case in which the electrode assembly may be housed.

According to the present disclosure, in the notching and stacking device for an electrode assembly and a secondary battery and the electrode assembly and the secondary battery manufactured by using the same, a stack and a separator can be fixed by stitching at the same time as notching, and, thus, product defects due to distortion that occurs during stacking of the electrode assembly can be prevented.

However, the technical effects to be achieved in the embodiment of the disclosure are not limited to the technical problems mentioned above, and other technical effects not mentioned herein will be clearly understood from the following description by those skilled in the art to which the disclosure pertains.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to the present disclosure.

FIG. 2 is an exploded perspective view of the secondary battery shown in FIG. 1.

FIG. 3 is an enlarged view of an electrode assembly in the secondary battery of FIGS. 1 and 2.

FIG. 4 is a schematic diagram of a notching and stacking device for an electrode assembly for manufacturing a secondary battery according to the present disclosure.

FIGS. 5A to 5E are cross-sectional views of a notching and stacking device for an electrode assembly cut along the line 5-5′ in FIG. 4, showing the notching and stacking device during various different steps of a method for manufacturing an electrode assembly using the notching and stacking device.

FIGS. 6A to 6C are schematic diagrams of a notching and stacking device for the electrode assembly of FIG. 4 and are plan views of first and second separators stitched by a stitching part.

FIGS. 7A and 7B are cross-sectional views of two separators stitched by the stitching part of FIGS. 6A to 6C.

FIGS. 8A and 8B are cross-sectional views of two separators stitched by the stitching part of FIGS. 6A to 6C.

FIGS. 9A and 9B are perspective views of a battery pack comprising an exemplary secondary battery according to the present disclosure.

FIGS. 10A and 10B are, respectively, a perspective view and a side view showing a vehicle including an exemplary battery pack according to the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components“.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

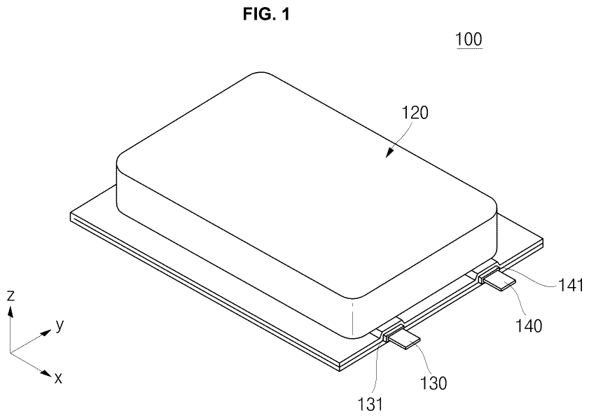

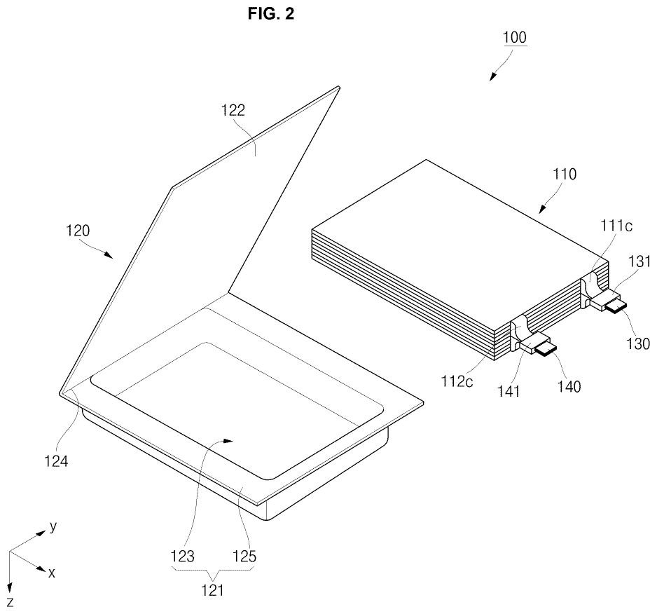

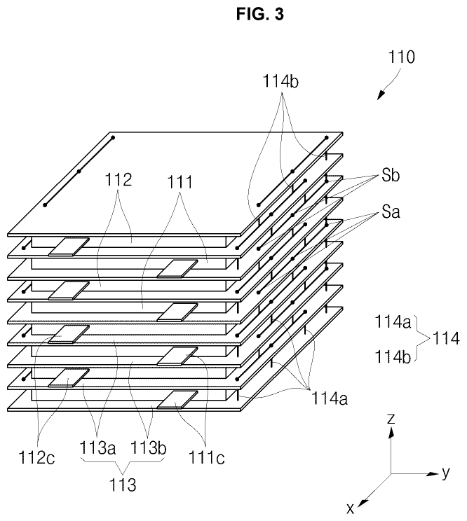

FIG. 1 is a perspective view of a secondary battery according to the present disclosure, FIG. 2 is an exploded perspective view of the secondary battery shown in FIG. 1, and FIG. 3 is an enlarged view of an electrode assembly housed in a case of the secondary battery of FIGS. 1 and 2.

Referring to FIGS. 1 and 2, the secondary battery 100 may include an electrode assembly 110 and a case 120 that houses the electrode assembly 110 and an electrolyte (optional) therein.

The electrode assembly 110 may include a separator 113 and may include a first electrode plate 111 and a second electrode plate 112 with the separator 113 interposed therebetween. In the electrode assembly 110, the first electrode plate 111, the separator 113, the second electrode plate 112, and another separator 113 may be sequentially stacked.

The secondary battery 100 may include a first electrode lead tab 130 electrically connected to a first electrode plate 111 of the electrode assembly 110, and a second electrode lead tab 140 electrically connected to a second electrode plate 112 of the electrode assembly 110.

The electrode assembly 110 may be formed by sequentially stacking the first electrode plate 111, the separator 113, and the second electrode plate 112, which are each formed in a thin plate shape or in a film shape, so that, together, the first electrode plate 111, the separator 113, and the second electrode plate 112 form a rectangular parallelepiped shape. Particularly, the electrode assembly 110 may be formed by sequentially stacking, multiple times, the separator 113, the first electrode plate 111, another separator 113, and the second electrode plate 112 in a third direction z to form a rectangular parallelepiped shape. The first electrode plate 111 may be a positive electrode plate, and the second electrode plate 112 may be a negative electrode plate, or vice versa.

The first electrode plate 111 is formed by applying a first electrode active material such as a transition metal oxide on a first electrode current collector formed of a metal foil such as aluminum. The first electrode may include or be referred to as a positive electrode. The first electrode active material may be provided on one side or both sides of the first electrode current collector, but the present invention is not limited thereto. Some regions of the first electrode current collector may be provided with a first electrode uncoated portion to which the first electrode active material is not applied. In addition, the first electrode uncoated portion may include a first electrode tab 111c which is a passage for current flow between the first electrode plate 111 and an outside of the positive electrode. The first electrode tab 111c may protrude from one end of the first electrode plate 111 in a first direction x. In addition, the first electrode tab 111c may be located at one side of a second direction y at one end in the first direction x. The first electrode tabs 111c of the plurality of stacked first electrode plates 111 may be aligned at a same position in the third direction z in the electrode assembly 110. The first electrode tab 111c may be a substrate tab formed by notching a portion of the first electrode uncoated portion.

The plurality of first electrode tabs 111c may be electrically connected to one first electrode lead tab 130 and may extend and protrude outwardly from an inside of the case 120. The first electrode lead tab 130 may be shaped as a flat plate that is thicker than each of the first electrode tabs 111c. In addition, an insulation tape 131 may be further interposed between the first electrode lead tab 130 and the case 120. The insulation tape 131 can secure an electrical insulation state between the case 120 and the first electrode lead tab 130.

The second electrode plate 112 is formed by applying a second electrode active material such as a transition metal oxide on a second electrode current collector formed of a metal foil such as copper or nickel. The second electrode may be a negative electrode or may include a negative electrode. The second electrode active material may be provided on one side or both sides of the second electrode current collector, but the present invention is not limited thereto. Some regions of the second electrode current collector may be provided with a second electrode uncoated portion to which the second electrode active material is not applied. In addition, the second electrode uncoated portion may include a second electrode tab 112c which is a passage for current flow between the second electrode plate 112 and the negative electrode. The second electrode tab 112c may protrude from one end of the second electrode plate 112 in the first direction x. In addition, the second electrode tab 112c may be located at the other side of the second direction y at one end in the first direction x. Particularly, the second electrode tab 112c may protrude in the same direction as the first electrode tab 111c and may be arranged parallel with the first electrode tab 111c. The second electrode tabs 112c of the plurality of stacked second electrode plates 112 may be aligned at a same position in the third direction z in the electrode assembly 110.

Such second electrode plates 112 are formed by applying a second electrode active material to a second electrode current collector, which is a roll-shaped metal foil, and then notching the current collector. Thus, a second electrode plate 112 having a second electrode tab 112c may be created.

In addition, the plurality of second electrode tabs 112c may be electrically connected to a second electrode lead tab 140 and may extend and protrude outwardly from the inside of the case 120. The second electrode lead tab 140 may be shaped as a flat plate that is thicker than the second electrode tab 112c. In addition, an insulation tape 131 may be interposed between the second electrode lead tab 140 and the case 120. The insulation tape 131 can create electrical insulation between the case 120 and the second electrode lead tab 140.

The separator 113 is positioned between the first electrode plate 111 and the second electrode plate 112 to prevent an electrical short and to enable the movement of transition metal ions. The separator may be made of polyethylene, polypropylene, or a composite film of polyethylene and polypropylene. However, the material of the separator 113 is not limited to the above-listed materials.

To more securely prevent an electrical short between the first electrode plate 111 and the second electrode plate 112, the separator 113 may be formed to have a larger width and length in both the first direction x and the second direction y than the first electrode plate 111 and the second electrode plate 112. Further, the separator 113 may have a larger plane size than the first electrode plate 111 and the second electrode plate 112.

In addition, the separator 113 may be connected to and fixed to an adjacent separator 113 in the third direction z on both sides of the second direction y by a fixing thread 114. For example, two separators 113 having the first electrode plate 111 interposed therebetween may be fixed by sewing the two separators together with the fixing thread 114. Likewise, two separators 113 having the second electrode plate 112 interposed therebetween may be fixed by sewing the two separators together with the fixing thread 114.

The fixing thread 114 may include a first fixing thread 114a that fixes the two separators 113 having the first electrode plate 111 interposed therebetween, and a second fixing thread 114b that fixes between two separators 113 having the second electrode plate 112 interposed therebetween.

In addition, the separator 113 may include a first separator 113a positioned on an upper side of the first electrode plate 111 or on a lower side of the second electrode plate 112 and may include a second separator 113b positioned on an upper side of the second electrode plate 112 or on a lower side of the first electrode plate 111.

The first fixing thread 114a may fix the first separator 113a and the second separator 113b to each other from the upper side of the first separator 113a and the lower side of the second separator 113b, and the second fixing thread 114b may fix the second separator 113b and the first separator 113a to each other from the upper side of the second separator 113a and the lower side of the first separator 113b. In addition, a first region S1, which is a region where the first fixing thread 114a penetrates and stitches the separators 113a and 113b, and a second region S2, which is a region where the second fixing thread 114b penetrates and stitches the separators 113a and 113b, may not overlap on a plane formed by the first direction x and the second direction y.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The case 120 may include a rectangular film extending in the first direction x, which is the longitudinal direction of the case 120, and a folded case body 121, and a case cover 122.

In addition, the case 120 may be configured such that, after the electrode assembly 110 is placed in a recess 123 provided in the case body 121, the case cover 122 is folded and combined with the case body 121 and then sealed. For example, the case 120 may be referred to as a pouch for a secondary battery.

The case 120 may be formed by folding a rectangular film extending along the first direction x based on a folding portion 124 extending along the second direction y that is perpendicular to the first direction x and that is a width direction of the case 120. As another example, the case body 121 and the case cover 122 may be formed as separate members, of which the folding portion 124 may not be provided. In some embodiments, the case 120 is in an integral form in which the case body 121 and the case cover 122 are formed on a single film, but other embodiments are not limited thereto. Even more particularly, in some embodiments, such as in exemplary embodiments described below, the case body 121 and the case cover 122 are formed on a single rectangular film.

The case cover 122 may have a rectangular flat plate shape. The case cover 122 may be in contact with and coupled to the case body 121 through the folding portion 124. The case cover 122 may cover an upper portion of the case body 121.

In addition, the case body 121 may include a recess 123 and an extension part 125. The case body 121 may have a recess 123 in which the electrode assembly 110 is placed at approximately the center and may include the extension part 125 extending approximately outwardly from three sides of the recess 123. For convenience, the edge of the case body 121 located on the outer side on a plane with respect to the recess 123 sealed with the edge of the case cover 122 is defined as the extension part 125. Particularly, the extension part 125 may be a surface that is parallel to and combined with the case cover 122. The recess 123 of the case body 121 may have a size allowing the electrode assembly 110 to be accommodated through a press or drawing process, or another similar process. In addition, the extension part 125 may extend outward from the four sides of the recess 123.

As another example, when the case body 121 and the case cover 122 are formed as separate members, the extension part 125 may also be provided in a region where the folding portion 124 is located. Of course, when the case body 121 and the case cover 122 are formed in an integral form, the extension part 125 may also be provided in the case body 121 adjacent to the folding portion 124.

After a portion where the recess 123 is formed is covered by the case cover 122, the extension part 125 and the case cover 122 may be combined and sealed by heat-melting the edge of the extension part 125 and the edge of the case cover 122. Therefore, the extension part 125 and the case cover 122 are heat-melted to combine and seal the case body 121.

The secondary battery 100 of the present disclosure is shown as having the electrode assembly 110 housed in the case 120, which may be pouch-shaped, but, in other embodiments, cases of various shapes may be used. For example, the case of the secondary battery 100 may be a prismatic secondary battery formed by a prismatic case having one open side of a roughly hexahedron, and a cap plate sealing the open side of the prismatic case. As another example, the case may be a prismatic secondary battery having a side terminal structure formed by a prismatic case having two opposite sides of a roughly hexahedron open, and two cap plates sealing each of the open sides of the prismatic case.

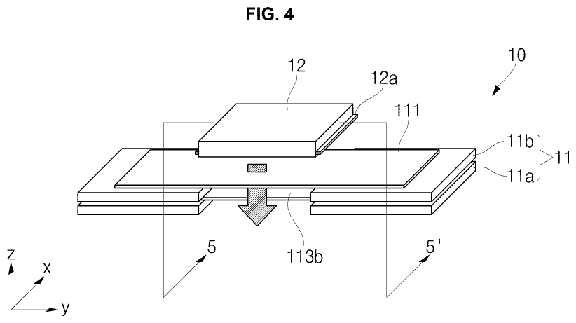

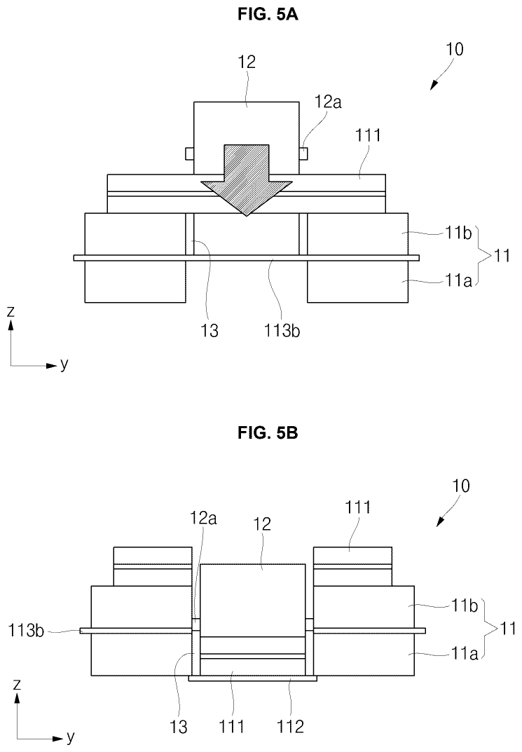

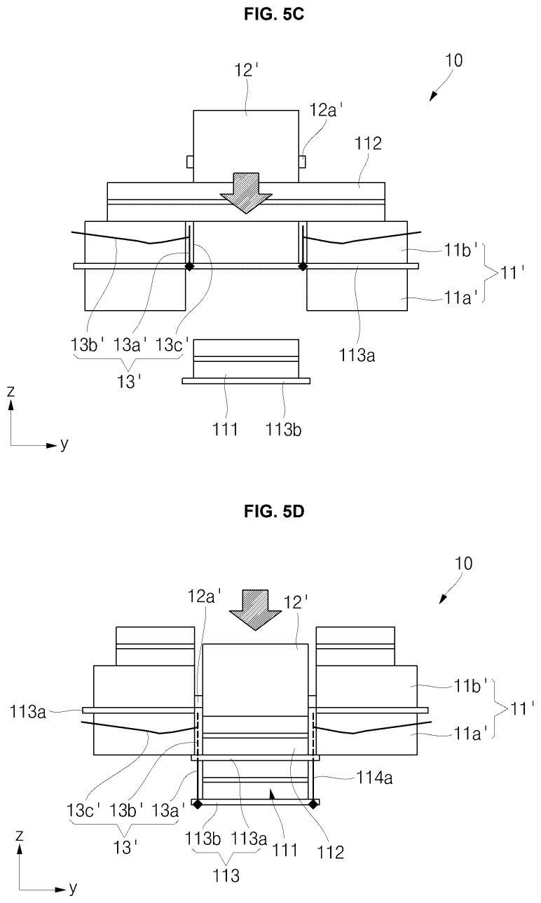

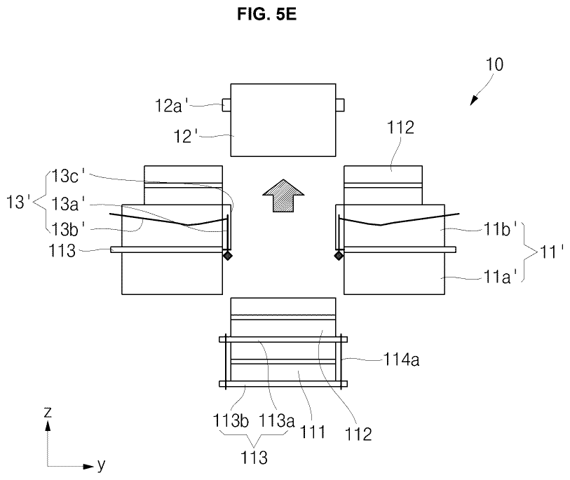

FIG. 4 shows a notching and stacking device for an electrode assembly, and FIGS. 5A to 5E are cross-sectional views of a notching and stacking device for an electrode assembly cut along the line 5-5′ in FIG. 4, showing the notching and stacking device during various different steps of a method for manufacturing an electrode assembly using the notching and stacking device.

Referring to FIGS. 4 and 5A, a notching and stacking device 10 for an electrode assembly is shown. The notching and stacking device 10 for an electrode assembly may include a die 11 on which the first electrode plate 111 and the second separator 113b are mounted, and a punch 12 for notching the first electrode plate 111 and the second separator 113b. Further, as seen in FIGS. 5C and 5D, the notching and stacking device 10 for an electrode assembly may additionally include a die 11′ on which the second electrode plate 112 and the first separator 113a are mounted, and a punch 12′ for notching the second electrode plate 112 and the first separator 113a.

First, the die 11 may include a first die 11a on which the second separator 113b is mounted, and a second die 11b on which a first electrode plate 111 is mounted. A hole corresponding to the outer circumference of the punch 12 may be perforated in the first die 11a and the second die 11b. The second separator 113b may be interposed between the first die 11a and the second die 11b to fix the same, and the first electrode plate 111 may be positioned and fixed on the upper side of the second die 11b. The punch 12 may penetrate the hole of the first die 11a and the hole of the second die 11b to notch the second separator 113b and the first electrode plate 111.

The hole of the first die 11a may be sized and positioned corresponding to the lower side of the hole of the second die 11b. The punch 12 may have a protruding region for providing an electrode tab protruding in the first direction x in a roughly rectangular shape on a plane. Particularly, a shape of the lower surface of the punch 12 may correspond to the shape of the first electrode plate 111 to be notched. The punch 12 may further include an auxiliary part 12a positioned on the upper side of the stitching part 13. The auxiliary part 12a may protrude in the first direction x and/or the second direction y from a side wall of the punch 12. The auxiliary part 12a may be provided so as to be spaced apart upward from the lower surface of the punch 12 by a first height. The auxiliary part 12a, which protrudes from the side wall of the punch 12, may not affect the shape of the first electrode plate 111 separated by the punch 12. That is, the first electrode plate 111 may be notched to a size corresponding to the lower surface of the punch 12. In this case a portion of the first electrode plate 111 adjacent to the notched portion and remaining on the second die 11b may be deformed due to the auxiliary part 12a. During notching, the punch 12 may move downward and notch the first electrode plate 111, and at the same time downwardly move the stitching part 13 located on the lower side of the auxiliary part 12a.

The stitching part 13 may be positioned in close contact with the inner circumferences of the holes of the dies 11a and 11b. Further, the stitching part 13 may cover the inner circumferences of the holes of the dies 11a and 11b. The stitching part 13 may include at least two needles 13a for stitching the separators 113 to each other, a thread 13b coupled to the needles 13a, and a gasket 13c which serves as a guide for the needles 13a and has a plurality of through holes for the needles 13a to penetrate.

The gasket 13c may be provided in a square ring shape on a plane, and may be provided with a plurality of through holes on at least both sides facing each other to receive the needles 13a. For example, the gasket 13c may be arranged such that the needles 13a are spaced apart from each other along the first direction x on both sides extending along the first direction x. In some embodiments, the height of the gasket 13c in the third direction z may be larger than the thickness of the first electrode plate 111. In some embodiments, the height of the gasket 13c in the third direction z may be greater than or equal to the sum of the thickness of the first electrode plate 111 and the first height (which is the height at which the auxiliary part 12a is spaced upward and apart from the lower surface of the punch 12).

The gasket 13c may further be provided with a cutting part for cutting the second separator 113b through the outer circumference on the lower side thereof. Particularly, when the punch 12 moves downward, the gasket 13c may move downward by the auxiliary part 12a of the punch 12 and may cut the second separator 113b. A planar inner circumference of the gasket 13c may correspond to a planar outer circumference of the punch 12, and a planar outer circumference of the gasket 13c may be larger than the planar outer circumference of the punch 12. Further, a plane size of the second separator 113b cut by the gasket 13c may be larger than a plane size of the first electrode plate 111. However, the protruding region for notching the electrode tab in the punch 12 may protrude further than the outer circumference of the gasket 13c on a plane.

The auxiliary part 12a may be positioned to correspond to the upper side of the gasket 13c. Further, the auxiliary part 12a may be provided to extend along the first direction x on both sides of the punch 12 from the upper side of the gasket 13c. The auxiliary part 12a may be provided only in a region where it can press and move the gasket 13c downward.

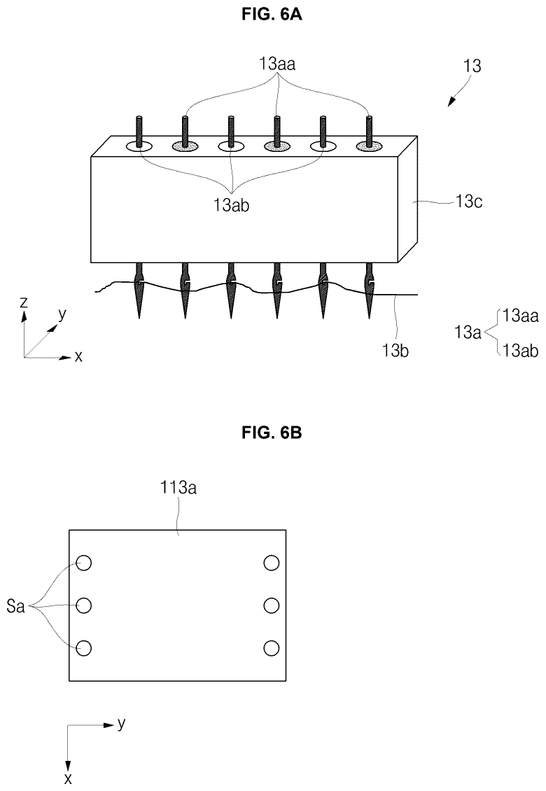

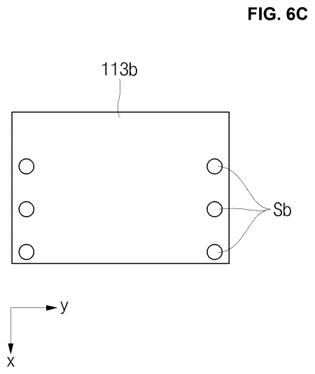

FIGS. 6A to 6C are a schematic diagrams showing of a notching and stacking device for an the electrode assembly of FIG. 4 and are plan views of first and second separators stitched by a stitching part.

First, the stitching part 13 may be provided with at least two needles 13a within the gasket 13c. The needles 13a may penetrate the gasket 13c and move along the third direction z including an upward direction and/or a downward direction.

In FIG. 6A, the needles 13a provided in the gasket 13c are six needles 13a, and the needles 13a are protruding upward from the gasket 13c. A first needle 13aa may be provided in the gasket 13c and a second needle 13ab may be provided in a gasket 13c′ coupled to the die 11′ on which the second electrode plate 112 and the first separator 113a are mounted. Further, in some embodiments, the first needle 13aa and the second needle 13ab for stitching the separators 113 to each other may not overlap on a plane. The first needle 13aa may stitch the first separator 113a and the second separator 113b to each other upward from the first separator 113a, the first electrode plate 111 interposed between the first separator 113a and the second separator 113b, and may be connected to the first fixing thread 114a. In addition, the second needle 13ab can stitch between the second separator 113b and the first separator 113a from the upper side of the second separator 113b, the second electrode plate 112 being interposed between the second separator 113b and the first separator 113a, and may be connected to the second fixing thread 114b.

A first region Sa may have stitches of the first fixing thread 114a connecting the first separator 113a and the second separator 113b, located on the upper side of the first separator 113a, and a second region Sb may have stitches of the second fixing thread 114b connecting the first separator 113a and the second separator 113b, located on the upper side of the second separator 113b. As shown in FIGS. 6B and 6C, the first region Sa and the second region Sb may not overlap.

The stitches of the first fixing thread 114a located on the lower side of the second separator 113b may also be located in the first region Sa, and the stitches of the second fixing thread 114b located on the lower side of the first separator 113a may also be located in the second region Sb.

The needles 13a may be moved downward by the auxiliary part 12a of the punch 12. In addition, a thread hook part for hooking the thread 13b may be provided on the lower side of each of the needles 13a. For example, if the first needle 13aa is provided as a plurality of first needles, the thread 13b may be hooked on the thread hook parts of the plurality of first needles 13aa, and two separators 113 may be stitched at once to be coupled by the first fixing thread 114a. After being fixed between the two separators 113 in the electrode assembly 110 by stitching, the thread 13b may be referred to as the fixing thread 114a and 114b.

Referring back to FIG. 5B, a cross-sectional view of a notching and stacking device during an initial stage of a manufacturing method is shown, in which the first electrode plate 111 and the second separator 113b are notched and stacked through the notching and stacking device 10 for an electrode assembly.

The punch 12 moves downward to notch the first electrode plate 111, and the auxiliary part 12a may notch the second separator 113b by moving the gasket 13c downward. In addition, the second separator 113b and the first electrode plate 111 may be stacked on the stack die at the same time as the notching. The stack die may be aligned with and placed on the lower side corresponding to the hole of the die 11. Further, when the punch 12 penetrates the holes of the dies 11a and 11b, the first electrode plate 111 and the second separator 113b may be notched and stacked on the stack die at the same time. The second separator 113b may be located on the lower side of the first electrode plate 111, and the first electrode plate 111 may be stacked on the upper side of the second separator 113b. Hereinafter, a configuration in which the first electrode plate 111 is stacked on the upper side of the second separator 113b will be referred to as a preliminary electrode assembly. The manufacturing method corresponds to an initial stage of manufacture, in which there is only one separator yet, and thus a separate stitching process may not be performed.

Referring back to FIGS. 5C to 5E, cross-sectional views of a notching and stacking device in subsequent stages of manufacture are shown, in which the first separator 113a and the second electrode plate 112 are notched and stacked on the upper side of the first electrode plate 111 by the notching and stacking device 10 for an electrode assembly.

First, as shown in FIG. 5C, the preliminary electrode assembly manufactured at the stage shown in FIG. 5B may be moved downward from the die 11′on which the second electrode plate 112 and the first separator 113a are mounted. In addition, the preliminary electrode assembly may be aligned with and positioned on a lower side corresponding to a hole of the die 11′.

Thereafter, as shown in FIGS. 5D and 5E, the second electrode plate 112 and the first separator 113a notched through the hole of the die 11′ may be stacked on the upper side of the preliminary electrode assembly. The configurations of the die 11', the punch 12', and the stitching part 13′ may be similar to those of the die 11, the punch 12, and the stitching part 13 described with reference to FIGS. 4 and 5A. However, a shape of the lower surface of the punch 12′ may correspond to a plane shape of the second electrode plate 112, and, thus, the punch 12′ may differ from the punch 12 with respect to a region where an electrode tab protrudes.

The punch 12′ may move downward and notch the second electrode plate 112, and the auxiliary part 12a′ may move the gasket 13c′ downward to notch the first separator 113a. In addition, the first separator 113a and the second electrode plate 112 may be stacked on the upper side of the preliminary electrode assembly at the same time as the notching. Particularly, when the punch 12′ penetrates the holes of the dies 11a′ and 11b′, the second electrode plate 112 and the first separator 113a may be notched and stacked on the upper side of the preliminary electrode assembly at the same time.

The first separator 113a may be interposed between the lower side of the second electrode plate 112 and the upper side of the first electrode plate 111, and may be stitched with the second separator 113b and combined and fixed by the stitches of the second fixing thread 114b.

The auxiliary part 12a′ may downwardly move the stitching part 13 when the punch 12′ moves downward and notches the second electrode plate 112 and the first separator 113a. The second needle 13ab of the stitching part 13′ may penetrate the first separator 113a and the second separator 113b. A thread 13b′ coupled to the second needle 13ab may penetrate the first separator 113a and the second separator 113b, so that the first separator 113a and the second separator 113b may be coupled by the second fixing thread 114b.

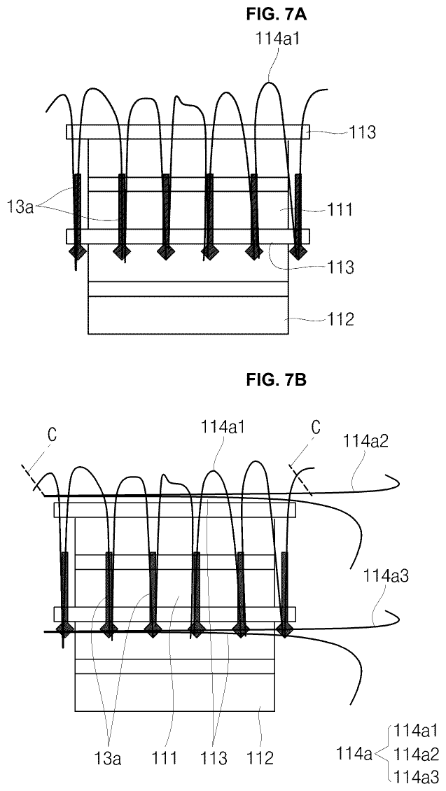

FIGS. 7A and 7B are cross-sectional views of two separators that are stitched through a thread. Each of the needles 13a included in the stitching part 13 may have one main thread 114a1 caught on a thread hook part and may penetrate two separators 113 to be stitched. In addition, an upper looper 114a2 and a lower looper 114a3 may be coupled to upper and lower sides, respectively, of the main thread 114a1 stitched as exemplified in FIGS. 7A and 7B. After the upper looper 114a2 and the lower looper 114a3 are coupled to the main thread 114a1, a tension of the main thread is adjusted and then fixed by the first fixing thread 114a through a knot, thereby completing the first fixing thread 114a.

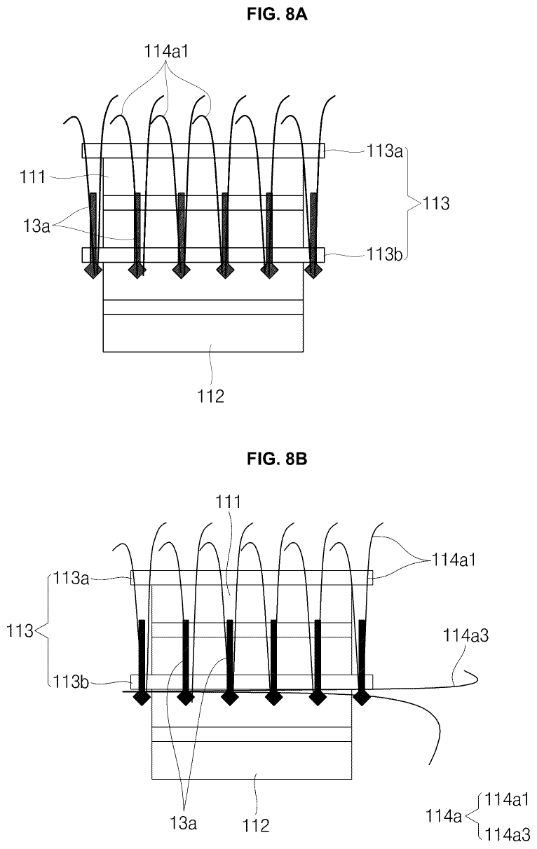

FIGS. 8A and 8B are cross-sectional views of two separators that are stitched through threads. A main thread 114a1 may be individually mounted on a thread hook part of each of the needles 13a included in the stitching part 13. Each of the needles 13a may penetrate the two separators 113 to be stitched. In addition, a lower looper 114a3 may be coupled to a lower side of the main thread 114a1 stitched as exemplified in FIGS. 8A and 8B. After the lower looper 114a3 is coupled to the main thread 114a1, a tension of the main thread 114a1 is adjusted and then fixed through a knot, thereby completing the first fixing thread 114a.

The secondary battery according to the above-described embodiment can be used to manufacture a battery pack.

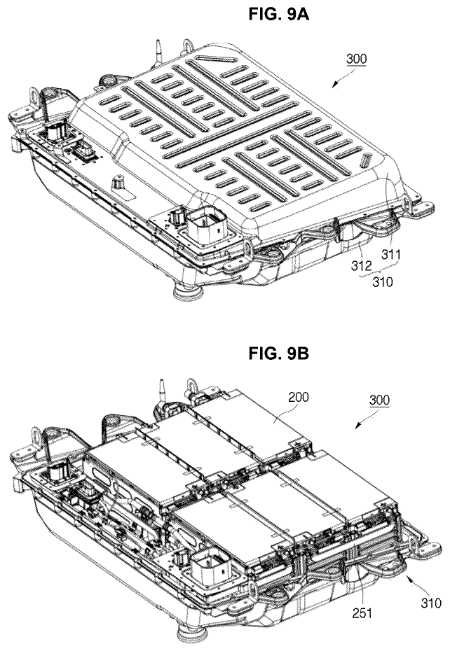

FIGS. 9A and 9B are perspective views showing an exemplary battery pack 300. The battery pack 300 may include a plurality of battery modules 200 and a housing 310 configured to accommodate the plurality of battery modules 200. For example, the housing 310 may include a first housing 311 and a second housing 312, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

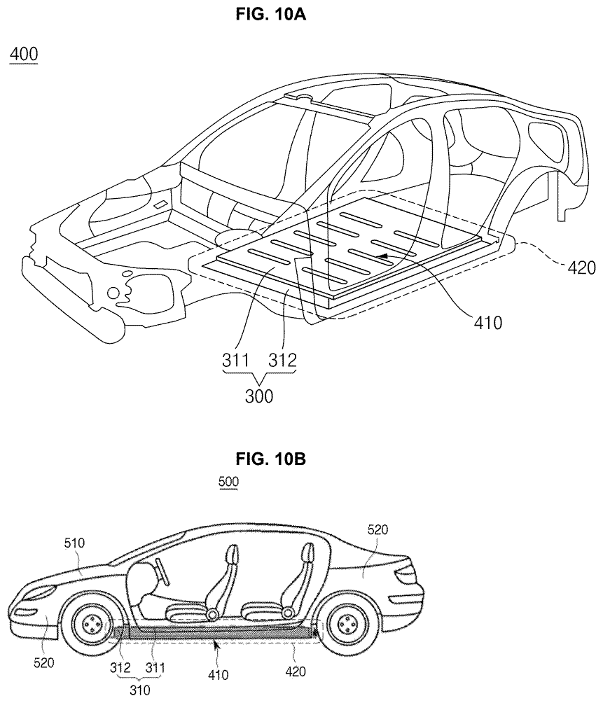

FIGS. 10A and 10B are, respectively, a perspective view showing an exemplary vehicle body 400 and a side view showing an exemplary vehicle 500. As shown in FIG. 10A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 10B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

The aforementioned embodiments are only some embodiments for implementing a secondary battery according to the present disclosure, the present disclosure is not limited to the above embodiments, and various modifications can be made to the above embodiments by anyone having ordinary skill in the art to which the disclosure pertains while still using the apparatuses and/or practicing the methods disclosed above.

What is claimed is:

1. A notching and stacking device for an electrode assembly, the device comprising:
a die with holes formed therein, the die including (i) a first die having a separator mounted thereon and including a first die hole, and (ii) a second die located on an upper side of the first die, the second die including an electrode plate mounted thereon a second die hole corresponding to the first die hole;
a punch disposed at the upper side of the die and penetrating the hole of the first die and the hole of the second die to notch the electrode plate and the separator; and
a stitching part in close contact with inner circumferences of the holes formed in the die, the stitching part configured to stitch and fix a notched separator and a stacked separator by using a fixing thread.

2. The notching and stacking device as claimed in claim 1, wherein the punch further comprises an auxiliary part that protrudes from a side wall of the punch, with the auxiliary part located on an upper side of the stitching part.

3. The notching and stacking device as claimed in claim 2, wherein the auxiliary part is spaced upward and apart from a lower surface of the.

4. The notching and stacking device as claimed in claim 2, wherein the stitching part comprises:
a gasket having a square ring shape in a plane and having a plurality of through holes extending through the gasket, the through holes extending between an upper side of the gasket and a lower side of the gasket;
needles positioned in the through holes of the gasket and capable of moving in a third direction, including an upward direction and a downward direction, by using the gasket as a guide; and
a thread connected to a thread hook part of each of the needles.

5. The notching and stacking device as claimed in claim 4, wherein a height of the gasket is greater than or equal to a sum of a thickness of the electrode plate and a height that the auxiliary part is spaced upward and apart from a lower surface of the punch.

6. The notching and stacking device as claimed in claim 4, wherein a cutting part for cutting the separator before the separator is stacked is on an outer circumference on a lower side of the gasket.

7. The notching and stacking device as claimed in claim 4, wherein the gasket has a plurality of through holes on opposite sides, with the through holes facing each other and configured to receive the needles.

8. The notching and stacking device as claimed in claim 4, wherein the auxiliary part is on an upper side of the gasket.

9. The notching and stacking device as claimed in claim 1, further comprising a stack die aligned with and placed on a lower side of the holes of the die, wherein a portion of the separator notched via the punch and a portion of the electrode plate notched via the punch are sequentially stacked on the upper side of the stack die.

10. An electrode assembly manufactured by the notching and stacking device for the electrode assembly as claimed in claim 1, the electrode assembly including a first electrode plate, a first separator, a second electrode plate, and a second separator, all of which are in a plate shape and of which are sequentially and alternately stacked,
wherein a first region between the second separator and the first separator is coupled by a first fixing thread, and a first electrode plate is in the first region between the second separator and the first separator, and
wherein a second region between the first separator and the second separator is coupled by a second fixing thread, and a second electrode plate is in the second region between the first separator and the second separator.

11. The electrode assembly as claimed in claim 10, wherein the first region and the second region do not overlap in a plane.

12. The electrode assembly as claimed in claim 10, wherein each of the first fixing thread and the second fixing thread includes a main thread stitched through and between the first separator and the second separator with one thread, and an upper looper and a lower looper respectively connected to upper and lower sides of the main thread.

13. The electrode assembly as claimed in claim 10, wherein each of the first fixing thread and the second fixing thread includes a plurality of main threads stitched from top to bottom through and between the first separator and the second separator and include a lower looper coupled to a lower side of the plurality of main threads.

14. The electrode assembly as claimed in claim 10, wherein the first electrode plate includes a first electrode tab protruding in a first direction from one end of the first electrode plate, and the second electrode plate includes a second electrode tab protruding in the first direction from one end of the second electrode plate and being spaced apart in a second direction from the first electrode tab.

15. The electrode assembly as claimed in claim 14, wherein each of the first fixing thread and the second fixing thread fix together a side of the first separator and a side of the second separator along the first direction.

16. The electrode assembly as claimed in claim 14, wherein a plane size of the separator is larger than a plane size of the first electrode plate or the second electrode plate, and the first electrode plate and the second electrode plate do not overlap on a plane in the first region and the second region.

17. A secondary battery comprising the electrode assembly as claimed in claim 10, the secondary battery including a case in which the electrode assembly is housed.
